(19) United States
(12) Patent Application Publication
(10) Pub. No.: US 2021/0388585 A1
(43) Pub. Date: Dec. 16, 2021

(54) Hand Washing Timer Kit

(71) Applicants: Shanreka Hamilton, Deerfield Beach, FL (US); Rodell Roper, Deerfield Beach, FL (US)

(72) Inventors: Shanreka Hamilton, Deerfield Beach, FL (US); Rodell Roper, Deerfield Beach, FL (US)

(21) Appl. No.: 17/314,654

(22) Filed: May 7, 2021

Related U.S. Application Data
(60) Provisional application No. 63/037,141, filed on Jun. 10, 2020.

(51) Int. Cl. E03C 1/05; A47K 5/12; G04F 1/00

(52) U.S. Cl. CPC E03C 1/057; G04F 1/005; A47K 5/1217

(57) ABSTRACT

A hand washing timer kit that displays a countdown timer for an appropriate hand washing session along with hand washing instructions. The hand washing timer kit has a water dispenser to dispense a quantity of water and a soap dispenser to dispense a quantity of soap, wherein both the water and the soap are dispensed in a touchless manner using an infrared proximity sensor system. The timer displays the countdown from a preconfigured maximum value to zero to allow a user to wash the hands for the desired duration. The instruction display displays the hand washing instructions throughout the duration of the washing session, and an integrated speaker plays the hand washing instructions and/or the countdown. The sensor system detects when soap has been dispensed, and delays the availability of water until the washing session duration has elapsed.

### CROSS-REFERENCE TO RELATED APPLICATION

The present application claims priority to, and the benefit of, U.S. Provisional Application No. 63/037,141, which was filed on Jun. 10, 2020 and is incorporated herein by reference in its entirety.

### FIELD OF THE INVENTION

The present invention relates generally to the field of hand hygiene systems. More specifically, the present invention relates to an improved hand washing system featuring a timer kit and a digital display, which is designed to notify a user when he or she has successfully washed their hands for a predetermined time period. More specifically, the hand washing system shows a predetermined timer countdown and instructions for washing and sanitizing the user's hands properly. In this manner, the present invention offers a novel way of reducing the spread of germs, viruses, and bacteria by ensuring that all users wash their hands for a minimum amount of time. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, millions of people die each year from a myriad of different infectious diseases and the spread of germs, viruses, bacteria or other harmful pathogens and microbes. In the time of a pandemic, such as the current COVID-19 pandemic, individuals may easily transmit and contract various infectious diseases by coming into contact with other individuals. Typically, an individual's hands are one of the main pathways for the transmission of infectious diseases, germs and other harmful pathogens. For example, the hands may come into contact with contaminated surfaces or objects, or when a user blows his or her nose, coughs or sneezes into their hands, or touches an infected person. When an individual with dirty and/or infectious hands then touches their eyes, nose and/or mouth, the action may result in the individual becoming infected. Therefore, proper hand hygiene is one of the most important ways to avoid becoming infected or infecting others. Proper hand hygiene typically involves frequent hands washings with soap and water for a predetermined amount of time to remove invisible viruses, bacteria and other harmful pathogens or any visible dirt that gets stuck to the individual's hands.

For protection against infectious diseases, such as COVID-19 and others, various health related organizations such as the Centers for Disease Control and Prevention (CDC) have set forth guidelines for individuals to scrub and wash their hands with soap and water for at least twenty seconds. As per the guidelines, a minimum of twenty seconds of proper hand washing allows for enough time to be thorough, and for the soap molecules to kill any bacteria present on the hands of the individual engaged in the washing process. However, many individuals are either unaware of the guidelines or have difficulty determining when an appropriate amount of time has passed during the hand washing session. For example, studies have shown that most individuals only wash their hands for 5-10 seconds, which may not be enough to clean the hands properly and remove any germs or other harmful pathogens therefrom.

Therefore, there exists a long felt need in the art for a hand washing system that enables individuals to wash their hands properly and for an optimal length of time. More specifically, there is a long felt need in the art for a hand washing system that tracks the amount of time that an individual washes his or her hands, and ensures that said time is no less than twenty seconds. Additionally, there is a long felt need in the art for a hand washing timer kit that senses the dispensing of soap onto the hands of an individual and delays the release of water to rinse the soap from the hands of the individual for at least twenty seconds, or another user specified duration. Moreover, there is a long felt need in the art for a hand washing timer kit that can be incorporated into a plumbing fixture at the time of manufacture, or that can be provided as an aftermarket kit and attached to an existing plumbing fixture. Finally, there is a long felt need in the art for a had washing timer kit that is relatively inexpensive to manufacture, reduces the spread of germs, viruses and other harmful pathogens, and is both safe and easy to use.

The subject matter disclosed and claimed herein, in one embodiment thereof is a novel hand washing timer kit designed to ensure proper hand washing for a minimum duration of at least twenty seconds. The hand washing timer kit is preferably comprised of a water dispensing unit for dispensing water through a water outlet, a cleansing solution dispensing unit for dispensing a predetermined amount of cleansing solution through another outlet, a timer for monitoring a predetermined duration of time, a time display unit for displaying a countdown time, an instruction display unit for displaying hand washing instructions, infrared proximity sensors for detecting hands below the water outlet or cleansing solution outlet, a reservoir for storing a cleansing solution, and a cleansing solution level detector for detecting the level of remaining cleansing solution in the reservoir.

In this manner, the novel hand washing timer kit of the present invention accomplishes all of the forgoing objectives, and provides a relatively easy, convenient and effective solution to ensure that an individual is aware of the proper amount of time to wash his or her hands. The hand washing timer kit of the present invention is also user-friendly as it reminds the individual of the appropriate duration of proper hand washing and reduces the spread of germs, viruses, bacteria and other harmful pathogens.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a hand washing timer kit designed to ensure proper hand washing for a minimum duration of twenty seconds. The hand washing timer kit is comprised of a water dispensing unit for dispensing a quantity of water through a water outlet, a cleansing solution dispensing unit for dispensing a pre-determined amount of cleansing solution through an outlet, a timer for monitoring a duration of time, a time display unit for displaying the remaining time, an instruction display unit for displaying hand washing instructions and other useful information, infrared proximity sensors for detecting hands below the water outlet or cleansing solution outlet, a reservoir for storing cleansing solution, and a cleansing solution level detector for detecting the remaining level of cleansing solution in the reservoir.

In a further embodiment of the present invention, a method for cleaning hands using a hand washing timer kit is disclosed. The method comprises the initial steps of displaying hand wash instructions and a timing value on an instruction display unit and a timer display unit, respectively. Next, the proximity sensors detect a hand of an individual under a cleansing solution spout and trigger the timer to initiate the pre-determined time period as well as sends an instruction to a processor to dispense a predetermined amount of cleansing solution through a cleansing solution outlet. Next, an instruction is sent to the processor to delay the dispensing of water through a water outlet for the predetermined hand scrubbing time period to insure that the cleansing solution remains on the individual's hands for the minimum hand washing period, which is preferably at least twenty seconds. Once the pre-determined hand washing time period has elapsed, the water dispensing unit is triggered to automatically dispense water through the water outlet. Subsequently, the timing value is decreased from the predetermined timing value to zero and the instructions displayed on the instruction display unit change with the passing time.

In yet another embodiment of the present invention, an apparatus for assisting an individual to wash his or her hands for a pre-determined time duration and in accordance with displayed hand washing instructions is disclosed. The apparatus comprises a water dispenser for dispensing water, a soap dispenser for dispensing a soap or any other liquid cleansing solution, a soap dispensing infrared sensor to automatically dispense soap when the individual's hands are under the soap spout, a water dispensing infrared sensor to automatically dispense water when the individual's hands are under the water spout and a duration of time has elapsed, a timer display to display a countdown of time (e.g., twenty seconds), and an instruction display to display hand washing instructions. Also, the rinsing water is not dispensed until receiving a signal from the soap dispensing infrared sensor, wherein the predetermined duration of at least twenty seconds has expired.

In still a further embodiment of the present invention, a washing faucet with integrated soap dispenser is disclosed, The faucet comprises a water dispenser configured to dispense water and a soap dispenser configured to dispense soap, wherein the water dispenser is delayed for a predetermined time period once the soap is dispensed from the soap dispenser. The faucet further comprises infrared sensors for touchless operation of both the water dispenser and the soap dispenser, an instruction display to display proper hand washing instructions and a timer display to display the remaining duration of a proper hand washing session. The time duration can be configured using a switch present on the washing faucet, or remotely through a smartphone application in wireless communication with a communication module positioned in the faucet.

The faucet may also comprise a speaker that plays the displayed instructions, and/or a timer value for user convenience.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the hand washing timer kit of the present invention in accordance with the disclosed architecture, wherein an individual is utilizing the device to wash his hands;

FIG. 2 illustrates a block diagram illustrating the essential components of one potential embodiment of the hand washing timer kit of the present invention in accordance with the disclosed architecture;

FIG. 3 illustrates a flow diagram illustrating one potential method of utilizing the hand washing timer kit of the present invention to ensure that a user washes his hands for a predetermined time in accordance with the disclosed architecture;

FIG. 4 illustrates a perspective view of one potential embodiment of the hand washing timer kit of the present invention in accordance with the disclosed architecture, wherein an individual is utilizing the device to wash his hands;

FIG. 5 illustrates a flow diagram illustrating one potential method of using a remote device to configure the hand washing timer kit of the present invention to ensure that a user washes his hands for a predetermined time in accordance with the disclosed architecture; and

FIG. 6 illustrates a perspective view of one potential embodiment of the display devices and speaker of the hand washing timer kit of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a hand washing timer kit that enables individuals to wash their hands properly and for an optimal length of time. More specifically, there is a long felt need in the art for a hand washing timer kit that tracks the amount of time that the individual washes his or her hands, and ensures that said time is no less than twenty seconds. Additionally, there is a long felt need in the art for a hand washing timer kit that senses the dispensing of soap onto the hands of an individual and delays the release of water to rinse the soap from the hands of the individual for at least twenty seconds, or another user specified duration. Moreover, there is a long felt need in the art for a hand washing timer kit that can be incorporated into a plumbing fixture at the time of manufacture, or that can be provided as an aftermarket kit and attached to an existing plumbing fixture. Finally, there is a long felt need in the art for a hand washing timer kit that is relatively inexpensive to manufacture, reduces the spread of germs, viruses, and other harmful pathogens, and is both safe and easy to use.

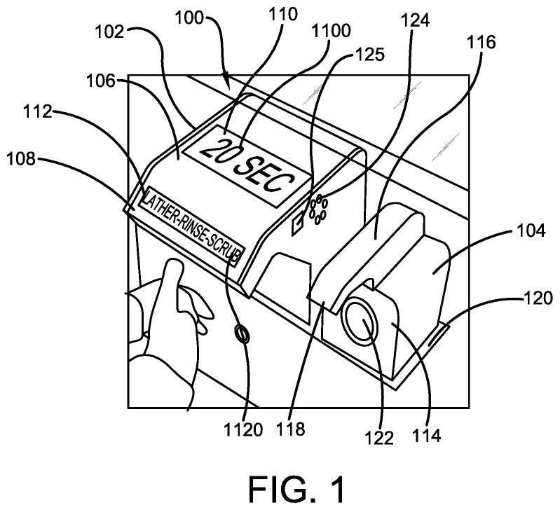

Referring initially to the drawings, FIG. 1 illustrates a perspective view of one potential embodiment of the hand washing timer kit 100 of the present invention in accordance with the disclosed architecture, wherein an individual 402 is utilizing the kit 100 to wash his hands 404. As shown, the hand washing timer kit 100 is comprised of a water dispensing unit 102 and a cleansing solution dispensing unit 104. The water dispensing unit 102 is in fluid communication with a pressurized water supply (not shown), such as a water supply line in a home or business, and is comprised of a water spout 106 having a water outlet 108 for dispensing water.

A timer display 110 is present on the surface of the water dispensing unit 102 and displays a real time timer value 1100 that decreases from an initial timer value, such as twenty seconds, to zero seconds. Nonetheless, the initial timer value 1100 can be pre-configured by the user to any period of time, though a minimum of 20 seconds is strongly recommended. The timer value 1100 displays the initial duration selected by the user 402 and begins the countdown once the device 100 senses the dispensing of the cleaning solution from the spout 116. The timer display 110 is also connected to a timer circuit 212 present within the water dispensing unit 102, which is configured with an initial value 1100. In addition to the timer display 110, an instruction display 112 is also present on the spout 106, and displays a set of general hand washing instructions 1120, such as “LATHER-SCRUB-RINSE”, to the user 212. The general hand washing instructions 1120 are pre-configured in the kit 100, and indicate the steps that the user 402 washing his or her hands needs to perform. The instructions 1120 may be displayed in a plurality of different languages or in braille for the blind. The instructions 1120 may also change along with the time shown on the timer display 110 to correlate each step in the hand washing process with the time elapsed during the hand washing process.

The cleansing solution dispensing unit 104 is comprised of a reservoir 114 to store a cleansing solution, such as a soap, detergent, lotion or handwash solution. A cleansing solution spout 116 is in fluid communication with the reservoir 114 and further comprises a cleansing solution outlet 118 to dispense a small amount of the cleansing solution upon demand. The hand washing timer kit 100 is preferably mounted on a generally flat surface using a flat base 120, wherein each of the water dispensing unit 102 and the cleansing solution dispensing unit 104 are attached to the flat base 120. Further, the flat base 120 has an aperture for a water pipe to connect to a nozzle present within the water dispensing unit 102. The reservoir 114 also has a soap level indicator 122 to view the level of remaining cleansing solution, and to alert the owner or a user when additional cleansing solution should be added to the reservoir 114.

It should be appreciated that both the water dispensing unit 102 and the cleansing solution dispensing unit 104 each have a sensor to detect the presence of the user's hands 404 under the water dispensing outlet 108 and/or the cleansing solution outlet 118, respectively, and trigger the kit 100 to dispense water and/or cleansing solution accordingly. The presence of the sensors are important because they enable the device 100 to dispense both the water and the cleansing solution without the user having to touch any part of the device 100, thereby maintaining hygiene and safety.

In addition to displaying the timer value 1100 and hand washing instructions 1120 via the timer display 110 and the instructions display 112, a speaker 124 is present in the kit 100 to play the instructions or the timer value, for example, for those who may not be able to read the display. Additionally, the speaker 124 can also play additional sounds or words, such as “WELCOME” or “HAND WASH COMPLETE” that are prerecorded and stored in a memory 125 of the device 100.

In the preferred embodiment, the kit 100 restarts itself after every twenty seconds to dispense water and cleansing solution. When not in use, both the timer display 110 and the instruction display 112 are turned OFF and are turned ON automatically when a user's hands 404 are detected by the proximity sensors (e.g., infrared sensors). This helps in reducing the battery drainage and preserving the longevity of the battery 216. Both the water dispensing unit 102 and the cleansing solution dispensing unit 104 may have wired or wireless connections between the various sensors and circuits present within the kit 100, and the kit 100 offers a way to reduce the spread of germs, viruses and bacteria by ensuring that all individuals using the device 100 are aware of the proper amount of time to wash the hands.

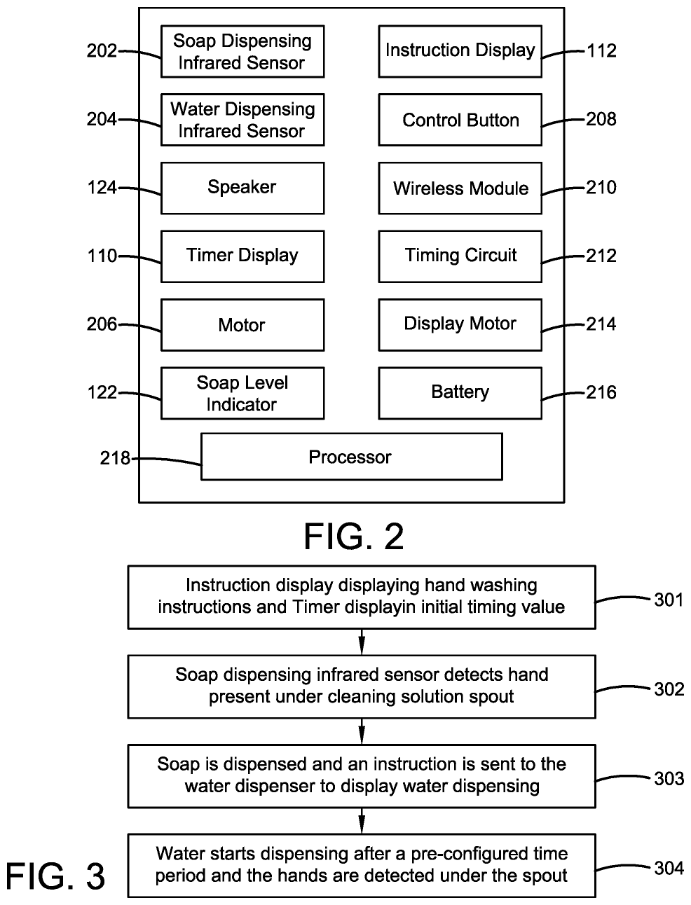

FIG. 2 illustrates a block diagram illustrating the essential components of one potential embodiment of the hand washing timer kit 100 of the present invention in accordance with the disclosed architecture. As shown, the hand washing timer kit 100 is comprised of a soap dispensing infrared sensor 202 which detects the presence of the user's hands 404 under the cleansing solution outlet 118 and triggers the device to dispense a predetermined amount of the cleansing solution from the cleansing solution reservoir 114. Importantly, a user need not press or touch any part of the device 100 to dispense the cleansing solution, thereby maintaining hygiene and safety. A water dispensing infrared sensor 204 that works in a similar manner as the soap dispensing infrared sensor 202 is present in the water dispensing unit 102 to dispense water from the water outlet 108, which is in fluid communication with a water supply as discussed above. The soap dispensing infrared sensor 202 and the water dispensing infrared sensor 204 may be of the same or different in configuration and/or size and are powered by the battery 216 or some other electrical source.

In the preferred embodiment of the present invention, when the soap dispensing infrared sensor 202 senses the presence of the user's hands 404, an instruction is sent from a processor 218 to the water dispensing unit 102 to delay the dispensing of water from the water outlet 108 until the timer value 1100 has elapsed, thereby preventing the user from prematurely rinsing the cleaning solution from his or her hands 404. The processor 218 sends instructions to each of the various components of the hand washing timer kit 100 requiring the same.

A display circuit 214 is connected to both the timer display 110 and the instructions display 112 to display the timer value 1100 and the instructions, respectively. A seven segment display can be used in one embodiment and, alternatively, an LED display can be used. The pre-configured timer value 1100 is stored in the timing circuit 212 or alternatively the memory 125, each of which are in electrical communication with the timer display 110 for displaying the configured timing value 1100. A relatively small motor/pump 206 may also be used to deliver the water and/or cleansing solution to the user to enable him or her to wash their hands 404. An internal battery 216 provides power to all of the various electronic components of the device 100, wherein the battery 216 is preferably a Li-Ion battery. Nonetheless, the device 100 may also be in electrical communication with a standard wall outlet or other electrical supply. As stated above, a soap level indicator 122 may also be included to indicate to the user 402 the remaining level of cleansing solution in the reservoir 114.

In order to configure the timing value 1100 of the timer circuit 212, a control button 208 may be present at an appropriate position on the washing kit 100. Alternatively, the configuration can be done using a paired companion mobile application installed on an electronic device, such as a smartphone or tablet (not shown). The pairing is done using a wireless connection channel provided by a wireless module/SoC 210 that utilizes a wireless technology such as, but not limited to, Wi-Fi/Bluetooth/WiMAX/RFIF/NFC. A QR code or serial number of the washing kit 100 may be used to pair the kit 100 and the smartphone application during the initial configuration. This is particularly useful for the administrators, housekeeping staff of an office or any business.

FIG. 3 illustrates a flow diagram illustrating one potential method of utilizing the hand washing timer kit 100 of the present invention to ensure that a user 402 washes his hands 404 for a pre-determined time interval 1100 in accordance with the disclosed architecture. More specifically, the method may begin at Block 301, wherein the instruction display 112 displays hand washing instructions 1120 and the timer display 110 displays the initial timing value 1100 (e.g., “20 SEC” to indicate to a user the proper hand washing routine and the duration of the hand washing session. At Block 302, the cleansing solution dispensing infrared sensor 202 detects the present of the user's hands 404 under the cleansing solution spout 116, releases a predetermined amount of cleansing solution onto the user's hands 202 and the countdown of the pre-determined time period begins.

At Block 303, the processor 218 sends an instruction to the water dispensing unit 102 to delay the dispensing of water from the water outlet 108 for the pre-determined time period even if the user's hands 404 are detected by the water dispensing infrared sensor. At Block 304 and after the pre-determined time period has elapsed, a quantity of water is dispensed from the water outlet 108 when the hands 404 are detected by the water dispensing sensor 204 to enable the user to rinse the cleansing solution from his or her hands 404. This method ensures that the user 402 properly cleans his or her hands 404 with soap or the cleansing solution for the desired duration before rinsing with water.

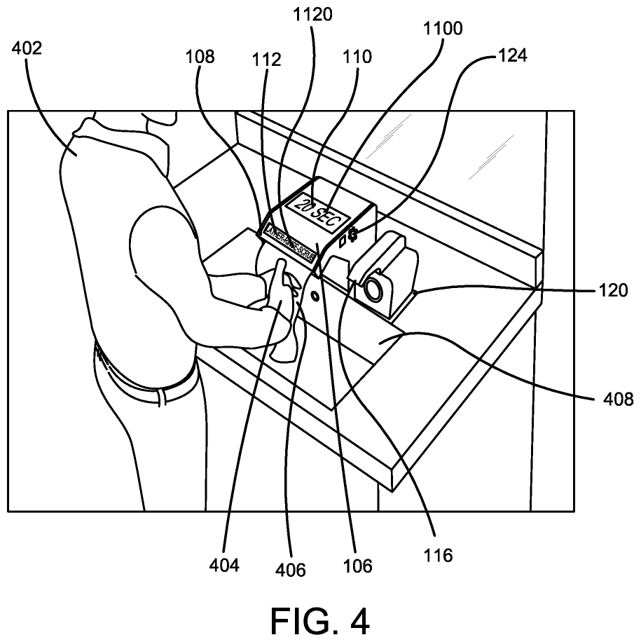

FIG. 4 illustrates a perspective view of one potential embodiment of the hand washing timer kit 100 of the present invention in accordance with the disclosed architecture, wherein an individual 402 is utilizing the device 100 to wash his hands 404. As shown, the hand washing kit 100 is installed on a sink 408 with the base plate 120 securely placed and fastened to the surface of the sink 408. The timer display 110 shows the countdown timer value 1100, thereby indicating the remaining duration of the hand washing session. Additionally, to ensure that the user 402 follows the complete routine of hand washing, an instruction display 112 displays the hand washing instructions 1120 for the user. More specifically, the user 402 approaches the sink 408 and reads the instructions 1120. When the user places his or her hands 404 under the soap dispensing spout 116, the timer begins to countdown from its initial value, which is preferably twenty seconds. When the countdown is complete, the user's hands 404 should be placed beneath the water faucet 106 and a quantity of water 406 will be dispensed to enable the user 402 to rinse the cleansing solution from his or her hands 404.

In addition to the displayed instructions, the speaker 124 may also play prerecorded instructions in various languages, as stated above. The washing kit 100 can be added to an existing sink or installed as an aftermarket device on an existing faucet. The sensor system detects when soap is dispensed, delaying the availability of water until the proper hand washing time has elapsed. Other audible alerts and instructions may also be available in the washing kit 100.

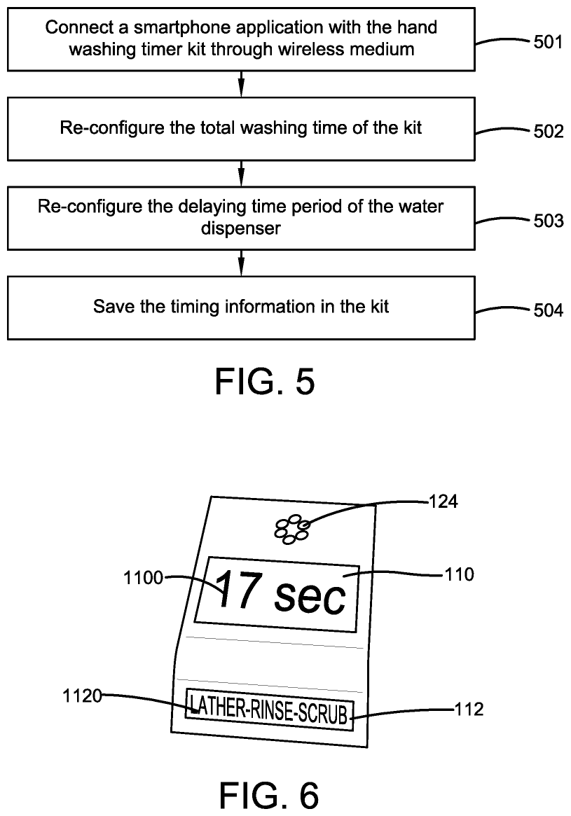

FIG. 5 illustrates a flow diagram illustrating one potential method of using a remote device to configure the hand washing timer kit 100 of the present invention to ensure that a user 402 washes his hands 404 for a predetermined time in accordance with the disclosed architecture. As shown, the hand washing timer kit 100 may be initially paired with a companion mobile application via a wireless communication channel, wherein a QR code or BSSID of the washing kit 100 can be used to connect the mobile application to the washing kit 100 at Block 501. The mobile application can be downloaded from any play store, such as Google PlayStore, Apple Store, etc. Using the wireless communication channel, the user-specified washing time or duration is configured at Block 502, wherein said duration can be later decreased or increased to suit user need and/or preference. As an additional step, the delayed time period for dispensing water from the device 100 may also be configured using the smartphone application at Block 503, and the various settings selected by the user are then saved at Block 504.

FIG. 6 illustrates a perspective view of one potential embodiment of the display devices 110, 112 and speaker 124 of the hand washing timer kit 100 of the present invention in accordance with the disclosed architecture. The speaker 124 can be placed at any appropriate location on the washing kit 100 without decreasing the effectiveness of the sound coming from the speaker 124. The timer display 110 displays the countdown time value 1100 in an illuminated manner. In one embodiment, the color of the display 110 can change to another color such as “RED” to indicate that the remaining time is approaching zero. The change in color can occur at a specific timer value such as seven seconds, for example. The instruction display 112 continuously displays the instructions 1120 during the countdown timer to help or remind a user about the proper hand washing routine.

Unless otherwise stated herein, the various components of the washing kit 100 can be comprised of a brass metal body with a silver, chrome or golden finish. Alternatively, the washing kit 100 may be manufactured of a copper, stainless steel, aluminum or other durable, corrosion-resistant material. The various sensors may require 6, 9 or 12 volts of power which may be provided by the internal battery 216. The amount of water flow and the soap dispensed from the device may also be customized to satisfy the user's needs or preferences. The soap reservoir 114 preferably stores more than four ounces of soap or cleansing solution, but can be of any shape or size that satisfies user need and/or preference.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “hand washing timer kit”, “kit”, “device”, “hand washing kit”, “washing kit”, and “hand washing system” are interchangeable and refer to the hand washing timer kit 100 of the present invention.

Notwithstanding the forgoing, the hand washing timer kit 100 of the present invention and its various components can be of any suitable size and configuration as is known in the art without affecting the overall concept of the invention, provided that it accomplishes the above stated objectives. One of ordinary skill in the art will appreciate that the size, configuration and material of the hand washing timer kit 100 and its various components as shown in the FIGS. are for illustrative purposes only, and that many other sizes and shapes of the hand washing timer kit 100 and its components are well within the scope of the present disclosure. Although the dimensions of the hand washing timer kit 100 and its components are important design parameters for user convenience, the hand washing timer kit 100 and its components may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A handwashing device comprising:
a water dispensing unit;
a soap dispensing unit; and
a timer.

2. The handwashing device as recited in claim 1 further comprising a sensor.

3. The handwashing device as recited in claim 2, wherein the water dispensing unit is in fluid communication with a water supply and the soap dispensing unit is in fluid communication with a reservoir containing a quantity of soap.

4. The handwashing device as recited in claim 3, wherein the water dispensing unit will not release a quantity of water until after a user specified time period has elapsed.

5. The handwashing device as recited in claim 4, wherein the user specified time period doesn't commence until the sensor senses a presence of a user's hands beneath a soap dispensing unit.

6. The handwashing device as recited in claim 5, wherein the user specified time period is at least twenty seconds.

7. The handwashing device as recited in claim 6 further comprising a display for displaying a set of handwashing instructions and the user specified time period.

8. The handwashing device as recited in claim 7, wherein the set of handwashing instructions are displayed in a plurality of different languages.

9. The handwashing device as recited in claim 6 further comprising a memory and a speaker.

10. The handwashing device as recited in claim 9, wherein the memory comprises a pre-recorded message that is played over the speaker.

11. The handwashing device as recited in claim 10, wherein the pre-recorded message is a set of handwashing instructions.

12. The handwashing device as recited in claim 11, wherein the set of handwashing instructions are in a plurality of different languages.

13. A handwashing device comprising:
a water dispensing unit comprised of a water spout, a water outlet and a water dispensing sensor, wherein the water outlet is in fluid communication with a water supply;
a soap dispensing unit comprised of a soap spout, a soap outlet, a soap dispensing sensor, and a soap level indicator, wherein the soap outlet is in fluid communication with a reservoir containing a quantity of soap;
a battery; and
a timer.

14. The handwashing device as recited in claim 13 further comprising a pump, a memory and a processor.

15. The handwashing device as recited in claim 14 further comprising a display and a speaker.

16. The handwashing device as recited in claim 15 further comprising a sensor.

17. The handwashing device as recited in claim 16, wherein the water dispensing unit will not release a quantity of water until after a user specified time period has elapsed.

18. The handwashing device as recited in claim 17, wherein the user specified time period doesn't commence until the sensor senses a presence of a user's hands beneath the soap outlet.

19. The handwashing device as recited in claim 18, wherein the user specified time period is at least twenty seconds.

20. A handwashing device comprising:
a base;
a water dispensing unit attached to the base and comprised of a water spout, a water outlet and a water dispensing sensor, wherein the water outlet is in fluid communication with a water supply;
a soap dispensing unit attached to the base and comprised of a soap spout, a soap outlet, a soap dispensing sensor, and a soap level indicator, wherein the soap outlet is in fluid communication with a reservoir containing a quantity of soap;
a battery;
a pump;
a display;
a timer circuit;
a speaker;
at least two sensors; and
a set of hand washing instructions.
